(19) United States
(12) Patent Application Publication
(10) Pub. No.: US 2012/0242152 A1
(43) Pub. Date: Sep. 27, 2012

(54) METHOD FOR SEARCHING GLOBAL MAXIMUM POWER POINT

(75) Inventors: Gerardo ESCOBAR, Baden (CH); Ngai-Man Ho, Fislisbach (CH); Sami Pettersson, Wettingen (CH); Leonardo-Augusto Serpa, Zurich (CH); Antonio Coccia, Baden (CH)

(73) Assignee: ABB Research Ltd, Zurich (CH)

(21) Appl. No.: 13/427,259

(22) Filed: Mar. 22, 2012

(30) Foreign Application Priority Data
Mar. 23, 2011 (EP) 11159367.9

(51) Int. Cl. H02J 1/00

(52) U.S. Cl. 307/77

(57) ABSTRACT

An exemplary method is disclosed for searching a global maximum power point in an arrangement comprising a series connection of photovoltaic power sources. The method can include determining a value of a reference by adding an increment to a previous value of the reference, wherein the value of the increment is determined on the basis of the power produced by the power sources.

### RELATED APPLICATION

This application claims priority under 35 U.S.C. §119 to European Patent Application No. 11159367.9 filed in Europe on Mar. 23, 2011, the entire content of which is hereby incorporated by reference in its entirety.

### FIELD

The present disclosure includes searching a global maximum power point (MPP) in photovoltaic applications where multiple local MPPs are present.

### BACKGROUND INFORMATION

Photovoltaic PV arrays receive non-uniform irradiation. These conditions may arise in cases where different photovoltaic panels connected in series are subjected to different conditions of irradiance and/or temperature. The irradiation may, for instance, be partially obstructed by passing clouds, neighboring buildings, trees, and dirt accumulated on the panels. This is an issue referred in the literature as partial shading [1].

FIG. 1a illustrates an arrangement of four series-connected photovoltaic panels. A current i flows through each of the series-connected panels. The series connection produces a voltage v. FIGS. 1b and 1c illustrate effects of partial shading for the arrangement. FIG. 1b shows the current i through the series connection in respect of the voltage v over the series connection. FIG. 1c shows a power produced by the series connection in respect of the voltage v. A situation where the panels receive uniform irradiation is represented by an iv-characteristic curve (dotted line) with a unique maximum power point (MPP). When the panels receive non-uniform irradiation, the iv-characteristic curve (solid line) becomes more complex as more local MPPs appear. The number of peaks (or local MPPs) depends on the number of panels and configuration of the series connection of PV panels.

An aspect of MPP tracking (MPPT) schemes is that they can be unable to distinguish a global MPP from a local one, as they are designed on the basis of an assumption that the PV curve has a single MPP. That is, an MPPT method may be able to accurately track a local maximum, but there may not be a guarantee that this local maximum is an optimal one. This may considerably reduce efficiency of the PV array in the case that the MPPT method follows a wrong MPP.

At this point, it may be convenient to differentiate an MPP searching (MPPS) and an MPP tracking (MPPT) methods. An MPPS method may be seen as a method able to find an optimal MPP among local MPPs at given operating conditions. However, an MPPS may be unable to track the MPP under changing conditions in a way an MPPT does. Therefore, it may be desirable to use an MPPS method in combination with an MPPT method. In this case, the MPPS may provide an initial point of operation in the vicinity of the global MPP from where the MPPT may start tracking the optimal MPP. Some authors recommend running a global MPPS on a periodical basis, and reset the starting point of the MPPT method once the vicinity of the global MPP is reached [2], [3].

Searching a global maximum among local maxima is a known problem in the optimization literature, and it is referred as the global optimization problem [4]. Embodiments of some optimization methods for PV applications are briefly described next.

In document [5], a searching method based on the Fibonacci series is proposed. The method iteratively modifies and shifts a searching range in such a way that the optimal point always lies inside such a searching range. Fibonacci series is used to fix a magnitude of the searching range, while evaluation of a minimization cost function is used to give a direction for the searching range shifting. If the global MPP is inside the searching range, the range decreases following the Fibonacci series. If the global MPP is presumed out of the actual searching range, the range is widened by reversing the Fibonacci series. This process continues until a pre-established limit is reached, wherein the limit depends on the last Fibonacci element considered.

In document [6], the authors propose use of a particle swarm optimization technique, a known technique of optimization, as a searching method for the PV application.

There are also methods based on the information provided by the iv-characteristic curve. For instance, in documents [2] and [3], a method based on using the iv-characteristic curve and a so called load line is proposed. The load line is defined as i=Rₚₘv where Rₚₘ is an equivalent resistance estimated by a ratio between 80% of an open circuit voltage V_{OC} and 90% of a short circuit current I_{SC}, i.e. Rₚₘ=0.8V_{OC}/0.9I_{SC}.

The idea is to monitor these two parameters, and to move an operating point of a voltage reference v_{ref} and a current reference i_{ref} to a vicinity of an intersection point of the iv-characteristic curve and the load line. The current reference i_{ref}. is gradually increased, starting from └v_{ref},i_{ref}┘=[V_{OC},0]. Once such a vicinity is reached, a switch to a regular MPPT method can be made. Moreover, a condition where the current at i(v_{ref})=i(0.8V_{OC}) is significantly lower than 0.9I_{SC} may be used as an indicator of the existence of a partial shading condition.

In document [7], a complex searching method is designed on the basis of observations made in an extensive study of the geometrical properties of PV power source characteristic curves. The complexity, however, may cause difficulties in implementing the method.

Document [8] discloses a method based on simply sweeping (or scanning or screening) the full iv-characteristic curve in an arrangement comprising a series connection of PV power sources. A flow diagram of this method is shown in FIG. 2. First, in block 21, a voltage reference v_{ref} is set to a minimum permissible voltage Vₘᵢₙ. A voltage v over the PV power sources is then controlled to correspond to the voltage reference. Next, in block 22, a voltage v_{MPP} and a power p_{MPP} in a highest found power point are initialized with the values of the voltage v over the PV power sources and the power iv produced by the PV power sources. In order to calculate the power, the voltage v and a current i through the PV power sources are determined.

Blocks 23 to 27 represent the core of the method. In block 23, the voltage v and a current i are determined, and the power p produced by the PV power sources is calculated, for instance, from the determined voltage v and current i. In blocks 24, the calculated power p is compared with the power p_{MPP} in the highest found power point. If the calculated power p exceeds the power p_{MPP} in the highest found power point, the highest found power point is updated in block 25 with the values of voltage v and power p.

The voltage reference v_{ref} is then updated in block 26, and the voltage v is controlled to correspond to the voltage reference v_{ref}. Next, in block 27, the voltage v is compared to a maximum permissible voltage Vₘₐₓ and the current i is compared to a minimum permissible current Iₘᵢₙ. If the voltage v is less than the voltage Vₘₐₓ and the current i is more than the current Iₘᵢₙ, the method is repeated starting from the block 23. Otherwise, a global MPP is found, and therefore, the voltage reference is set, in block 28, to the value of the voltage v_{MPP} in the highest found power point, and the method ends.

The method starts in a minimum permissible voltage and then gradually increases the voltage until a maximum allowed voltage or a minimum permissible current is reached. As the voltage gradually increases, the PV power source may not be able to operate at a global MPP. In other words, while searching the global MPP, the PV panels may not be able to produce a maximum power.

### SUMMARY

A method is disclosed for searching a global maximum power point in an arrangement having a series connection of photovoltaic power sources, and means for controlling a first quantity of the series connection, wherein one of two series connection quantities which represent a voltage over the series connection and a current through the series connection is defined as the first quantity and another of the two series connection quantities is defined as a second quantity, and wherein the method comprises: determining values for the first quantity, and the second quantity; determining a power (p) produced by the power sources; setting the value of the first quantity as a first parameter, when the value of the determined power exceeds a highest found power (p_{MPP}), wherein the first parameter represents the value of the first quantity at the highest found power; setting the determined power (p) as a new value of the highest found power, when the value of the determined power (p) exceeds a present value of the highest found power; determining a value of a first quantity reference by adding an increment to a previous value of the first quantity reference, wherein a value of the increment is determined based on the highest found power; controlling the first quantity based on the first quantity reference; and setting the first parameter value as the global maximum power point, when the first quantity reference or the second quantity has reached a set limit.

An apparatus is also disclosed for searching a global maximum power point of an arrangement having a series connection of photovoltaic (Pv) power sources, wherein one of two series connection quantities which represent a voltage over the series connection and a current through the series connection is defined as a first quantity, and another the two quantities is defined as a second quantity, the apparatus comprising: means for determining a power (p) produced by power sources; means for determining a value of a first parameter based on a highest found power, wherein the first parameter represents a value of the first quantity at the highest found power; means for determining a new value for the highest found power based on the determined power (p); means for determining a value of a first quantity reference by adding an increment to a previous value of the first quantity reference, wherein the value of the increment is determined based on the highest found power; and means for setting the first parameter value as a global maximum power point, when the first quantity reference or the second quantity has reached a set limit.

### BRIEF DESCRIPTION OF THE DRAWINGS

In the following, exemplary embodiments will be described in greater detail by reference to the accompanying drawings, in which:

FIGS. 1a, 1b, and 1c illustrate an arrangement having a series connection of PV power sources and an example of effects of partial shading for the arrangement;

FIG. 2 illustrates a flow diagram of a known method for searching global MPPs;

FIGS. 3a and 3b illustrate exemplary characteristic curves of a series connection of PV power sources, and some features of the curves;

FIG. 4 illustrates an exemplary voltage-based embodiment of the disclosed method;

FIG. 5 illustrates an exemplary operation of an embodiment;

FIG. 6 illustrates an exemplary current-based embodiment of the disclosed method;

FIG. 7 illustrates an exemplary arrangement having an apparatus for searching a global MPP;

FIGS. 8a and 8b illustrate exemplary simulated shapes of characteristic curves and points tested using an exemplary disclosed method;

FIG. 9 illustrates an exemplary simulated response of a voltage over PV power sources to a voltage reference produced by an exemplary disclosed method;

FIG. 10 illustrates an exemplary simulated PV power source power, and a stored highest found power;

FIG. 11 illustrates an exemplary simulated response of a PV power source voltage to a voltage reference produced by a known searching method;

FIGS. 12a and 12b illustrate an exemplary simulated pv-characteristic curve, a simulated iv-characteristic curve, and points tested using an exemplary method;

FIG. 13 illustrates an exemplary voltage response to a voltage reference produced by an exemplary disclosed method; and

FIG. 14 illustrates differences between an exemplary disclosed method and a known method.

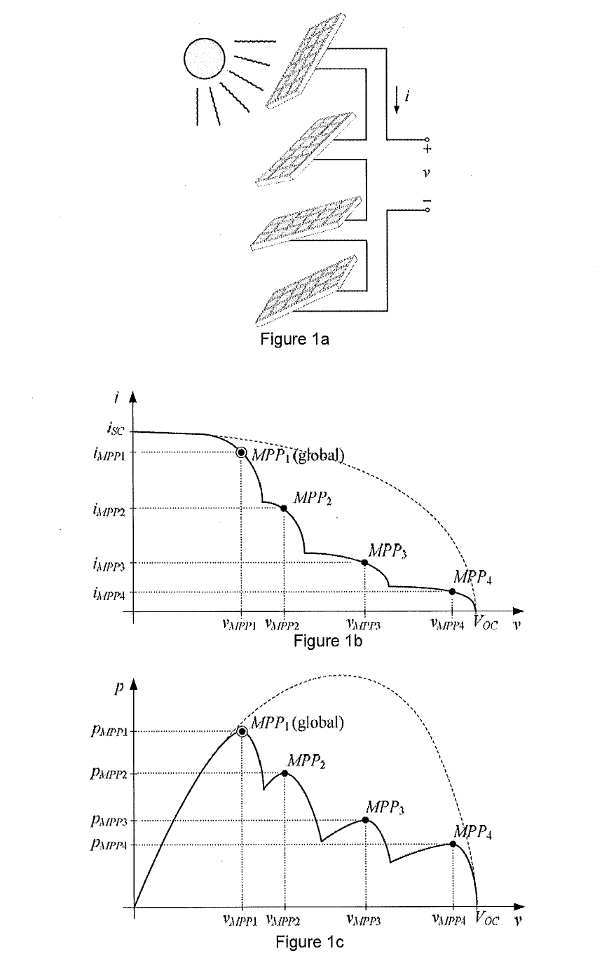

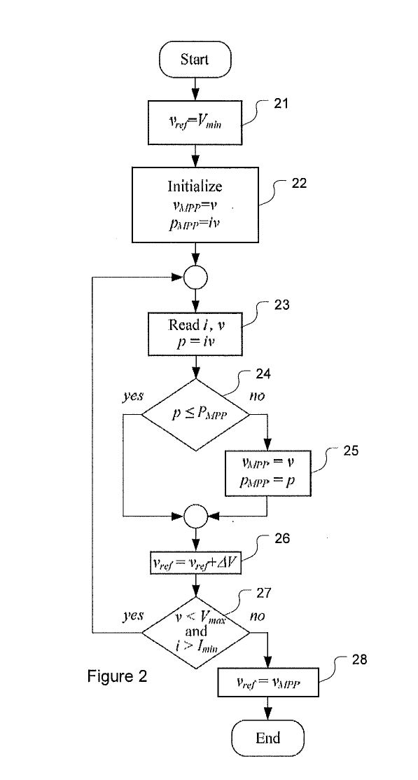

### DETAILED DESCRIPTION

The disclosure presents a method for searching a global maximum power point (MPP). The method is based on using geometrical characteristics of an iv-characteristic curve. The method produces a reference for either voltage or current which could be computed according to two options: by simply adding a constant increment, or by computing the next reference following the trajectory of an auxiliary hyperbole. The auxiliary curves are defined as rectangular hyperboles defining subspaces of constant power. The used quantity, either voltage or current, grows faster along the auxiliary hyperboles than along the iv-characteristic curve. This enables a possibility of considerably reducing a time used for searching. An exemplary method as disclosed herein can be simple to implement and be valid for an arbitrary number of local maxima, and be independent of the array configuration of PV power sources.

An exemplary method for searching a global maximum power point is described with respect to an arrangement having a series connection of photovoltaic (PV) power sources. A series connection of photovoltaic power sources may, in certain conditions, include multiple local MPPs. These conditions may arise when the power sources are subjected to different conditions of irradiance and/or temperature.

An exemplary method is based on geometrical characteristics of the iv-characteristic curve of the series connection of PV power sources, and a set of auxiliary rectangular hyperboles defined as

vi=P_{MPP} (1)

where P_{MPP} is a constant representing the power at a given point. Thus, the auxiliary curves hyperboles define subspaces of constant power.

The iv-characteristic curve and the auxiliary hyperboles are monotonically decreasing functions of voltage. The method includes sweeping the iv-characteristic curve at certain voltage or current increments, and using a trajectory of the hyperbole representing a highest found power to allow larger increments, as the used quantity grows faster along the hyperbole than along the iv-characteristic curve. This may result in considerable acceleration of the searching process.

The arrangement also can include means for controlling a first quantity of the series connection. The means may, for instance, be an inverter. One of following series connection quantities: a voltage over the series connection and a current through the series connection is defined as the first quantity, and the other one of the two quantities is defined as a second quantity. Thus, the method may be voltage-based or current-based. The former uses the voltage as the variable of control, in a sense that a voltage reference is generated, and the arrangement can include means for controlling a voltage over the series connection. The latter generates a current reference, in which case the arrangement can include means for controlling a current through the series connection. In the disclosed method, values for the first and the second quantities are determined. A power p produced by the power sources is also determined. This may be done, for instance, on the basis of the first and highest found power.

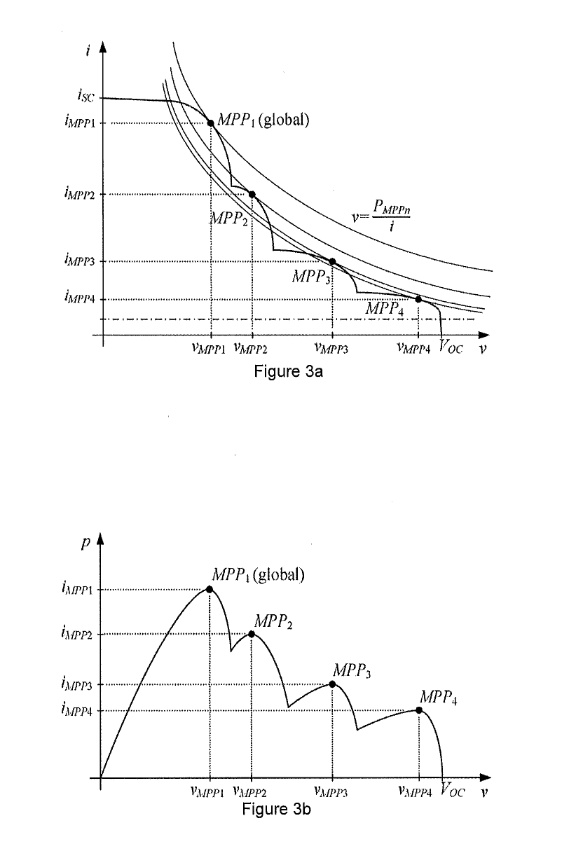

There can be a set of rectangular hyperboles intersecting the iv-characteristic curve. FIG. 3a illustrates an iv-characteristic curve of an arrangement having a series connection of PV power sources. In FIG. 3a, rectangular hyperboles form tangents to an iv-characteristic curve at local MPPs. FIG. 3b illustrates a pv-characteristic curve of the same arrangement. A hyperbole representing the MPP with highest power may be formed using Equation 1, where P_{MPP} is chosen as the highest found power among all previous tested points in the iv-characteristic curve. Also, it may be desired to store a value of the first quantity at the MPP with the highest power, as it may be used as a reference for the control after the search. For instance, in a voltage-based embodiment, this may be a voltage over the power sources at highest found power.

Therefore, an exemplary method may include setting the value of the first quantity as a first parameter, if the value of the determined power exceeds the highest found power p_{MPP}, the first parameter represents the value of the first parameter at the highest found power. Further, the determined power p is set as a new value of the highest found power p_{MPP}, if the value of the determined power p exceeds a present value of the highest found power p_{MPP}.

A value of a first quantity reference may then be determined by adding an increment to a previous value of the first quantity reference, wherein the value of the increment is determined on the basis of the highest found power. The method may sweep the iv-characteristic curve at certain increments of the first quantity reference, and use the hyperbole representing the MPP with highest power to allow larger increments.

For instance, a voltage (current) reference maybe gradually increased starting from a minimum voltage (current) reference to a maximum permissible voltage (current). The effective increment can be enlarged by using the trajectory of the hyperbole. As a result of using the hyperbole for enlarging the increment as disclosed, considerable acceleration of the searching process may be achieved. For instance, for a given current, a voltage coordinate of the corresponding point on the hyperbole can be considerably larger than a voltage coordinate of the corresponding point in the iv-characteristic curve. Generally speaking, voltage grows faster along the hyperbole than along the iv-characteristic curve.

Determining the value of the first quantity reference may, for instance, be done in a following manner. If the value of the determined power p does not exceed the highest found power p_{MPP}, a second parameter is calculated by dividing the highest found power p_{MPP} by the second quantity. A sum of the first quantity reference and a minimum increase is calculated and the second parameter is compared with the sum. If the second parameter is larger than the sum, the second parameter is set as the first quantity reference. Otherwise the sum is set as the first quantity reference. The sum is set as the first quantity reference also if the value of the determined power p exceeds the highest found power p_{MPP}.

After the first quantity reference is determined, the first quantity may be controlled on the basis of the first quantity reference. For instance, an inverter may be used to produce a voltage (current) on the basis of a voltage (current) reference.

When the first quantity or the second quantity has reached a set limit, the highest found value for the first quantity reference may be set as the global maximum power point.

The proposed method may operate at a regular sampling frequency, where the sampling interval is represented by T_{S}. A sub-index k is used to refer to variables at the kth sampling time, e.g. vₖ, v_{ref,k}, etc.

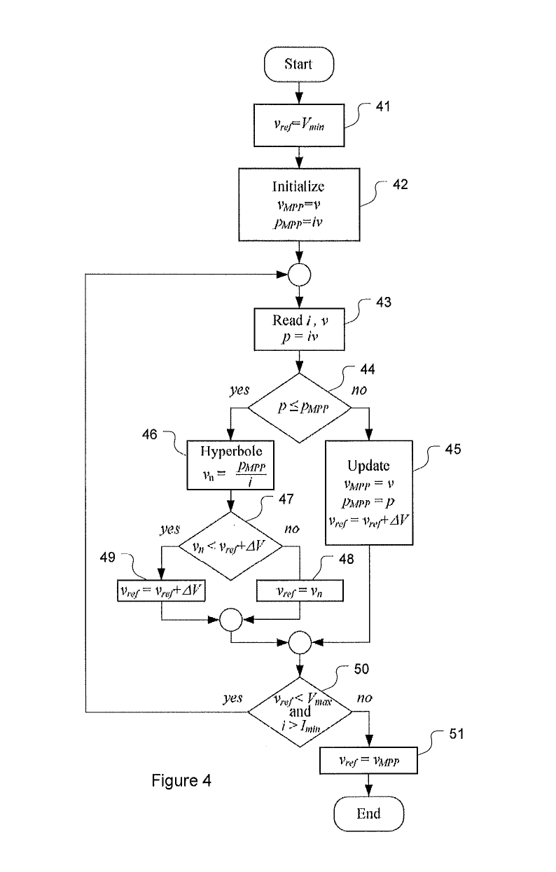

As mentioned herein, the method may be voltage-based or current-based. FIG. 4 illustrates a flow diagram of an exemplary voltage-based embodiment of the disclosed method. A voltage v over the series connection of PV panels represents the first quantity and a current i through the series connection represents the second quantity. A voltage reference v_{ref} represents the first quantity reference. An inverter may, for instance, be used as the means for controlling the voltage v to correspond to the voltage reference v_{ref}.

The method computes an increasing voltage reference v_{ref,k+1} at every new sampling time, starting from a minimum permissible voltage Vₘᵢₙ. In FIG. 4, in block 41, a voltage reference v_{ref} is set to the minimum permissible voltage Vₘᵢₙ. Next, in block 42, a highest found power p_{MPP} and a voltage v_{MPP} at the highest found power are initialized with the values of the voltage v and the power iv produced by the PV power sources. In FIG. 4, the voltage v_{MPP} represents the first. In order to calculate the power p produced by the PV power sources, the voltage v and a current i through the PV power sources are determined.

The new voltage reference V_{ref,k+1} may be computed by adding a minimum increment ΔV to the previous voltage reference v_{ref,k}:

v_{ref,k+1}=v_{ref,k}+ΔV. (2)

Alternatively, a trajectory of the hyperbole representing the MPP with highest power may be followed. The new reference v_{ref,k+1} may be calculated by dividing the highest found power p_{MPP} among the previous visited points in the iv-characteristic curve by the current at point k:

$${v}_{ref , k + 1} = \frac{{p}_{MPP}}{{i}_{k}} \qquad ( 3 )$$

The method follows a set of rules in determining the size of the increment. If a determined power pₖ, in a given point k, is larger than the highest found power p_{MPP}, the voltage reference is computed by using Equation 2. Information of the highest found MPP is updated with the information of voltage vₖ and power pₖ at point k, i.e. v_{MPP}=vₖ,p_{MPP}=pₖ. If the power pₖ, in a given point k, is smaller than the highest found power p_{MPP}, the new voltage reference is computed using Equation 3. If the resulting increment, given by v_{ref,k+1}−v_{ref,k} is smaller than ΔV, the method recalculates using Equation 2.

The above rules guarantee that the increment produced will not be smaller than ΔV. The process stops whenever a maximum permissible voltage Vₘₐₓ or a minimum permissible current Iₘᵢₙ is reached.

In FIG. 4, blocks 43 to 50 represent Equations 2 and 3, and the above rules. In block 43, the voltage v and a current i are determined, and the power p is calculated, for instance, from the determined voltage v and current i. In block 44, the calculated power p is compared with the power p_{MPP} in the highest found power point.

If the calculated power p exceeds the power p_{MPP} in the highest found power point, the highest found MPP is updated in block 45 with the values of voltage v and power p. The voltage reference v_{ref} is also updated with the minimum increment in block 45.

If the calculated power p does not exceed the power p_{MPP}, an intermediate voltage vₙ, as a second parameter, is calculated in block 46 by dividing the power p_{MPP} by the current i. A sum of the voltage reference v_{ref} and the minimum increment ΔV is calculated and the intermediate voltage vₙ is compared in block 47 with the sum.

If the intermediate voltage vₙ is larger than the sum, the intermediate voltage vₙ is set as the voltage reference v_{ref} in block 48. Otherwise, the sum is set as the voltage reference v_{ref} in block 49.

Next, in block 50, the voltage v is compared to a maximum permissible voltage Vₘₐₓ and the current i is compared to a minimum permissible current Iₘᵢₙ. If the voltage v is less than the voltage Vₘₐₓ and the current i is more than the current Iₘᵢₙ, the method is repeated starting from the block 43. Otherwise, a global MPP is found, and therefore, the voltage reference is set, in block 51, to the value of the voltage v_{MPP} at a highest found power, and the method ends.

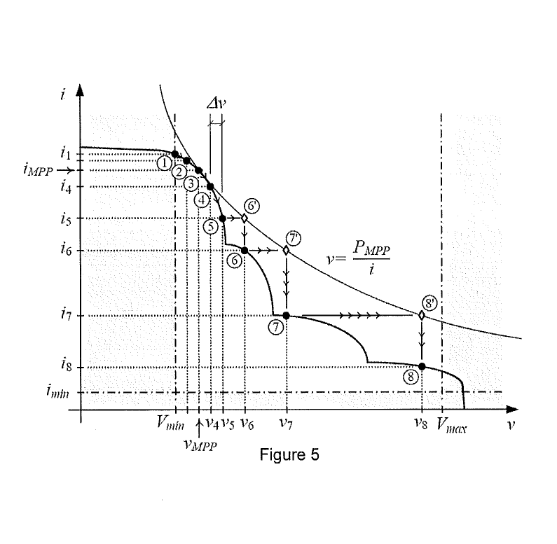

FIG. 5 illustrates an example of operation of the embodiment in FIG. 4. The searching process starts by fixing the voltage reference v_{ref,1} equal to the minimum permissible voltage Vₘᵢₙ at point 1 (k=1) on the iv-characteristic curve. Then, an increment ΔV is added to the reference voltage v_{ref,1}, resulting a reference voltage v_{ref,2}at point 2, i.e. v_{ref,2}=v_{ref,1}+ΔV. As power p₂ at point 2 is bigger than at point 1, the voltage and power values of the MPP are updated using the information of point 2, that is, v_{MPP}=v₂, P_{MPP}=p₂.

The process is repeated until point 4 is reached. The maximum power was reached in the intermediate point 3, and thus the information for the MPP was updated with the information of point 3 at that previous instant, that is, v_{MPP}=v₃, p_{MPP}=p₃.

At point 4, p₄≦p_{MPP}, and thus, a new voltage reference v_{ref,5} is computed following the trajectory of the actual hyperbole, i.e., v_{ref,5}=P_{MPP}/i₄, where the present current i₄ is used. However, the increment produced following the hyperbole trajectory is smaller than the increment ΔV, i.e. v_{ref,5}−v_{ref,4}<ΔV. Therefore, the method calculates the new voltage reference by adding an increment ΔV according to Equation 2.

At point 5, p₅≦p_{MPP}, and thus, the trajectory of the hyperbole may again be used to compute a new voltage reference. The new voltage reference is given by v_{ref,6}=p_{MPP}/i₅, where i₅ is the current at point 5. This gives an auxiliary point 6′ on the hyperbole. As the voltage increment obtained is larger than ΔV, i.e. v_{ref,6}−v_{ref,5}>ΔV, the method moves to point 6 on the PV curve. Point 6 has the same voltage coordinates as point 6′.

The process is repeated until point 8 is reached. As p₈<p_{MPP} again at point 8, the next point may be computed using Equation 3. However, it can be observed that v_{ref,9}>Vₘₐₓ, and thus the method stops the searching process.

The method allows an arbitrary number of local MPPs, where the global MPP can be located in any relative position with respect to the rest of the local maxima. The embodiment of FIG. 4 produces faster results whenever the global MPP is located in the lowest voltage values (e.g., at the very beginning of the searching process, as in the above example of FIG. 5).

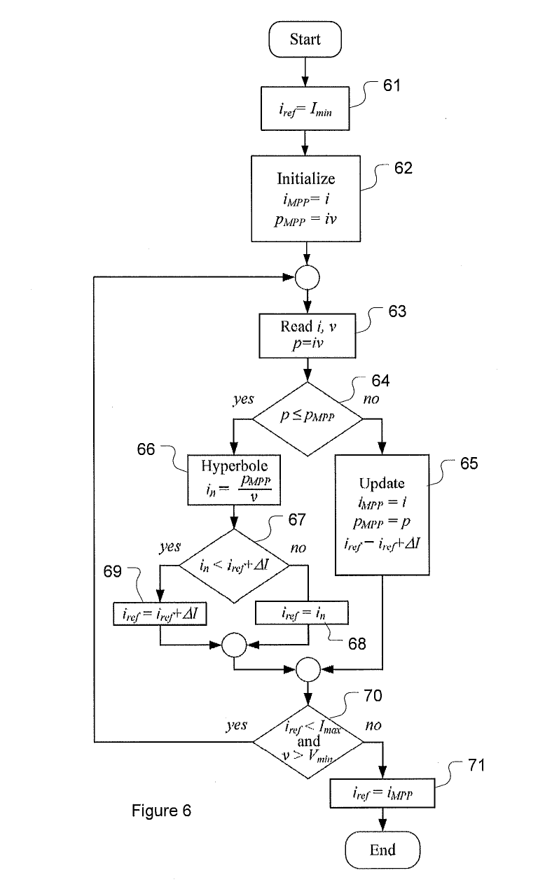

FIG. 6 illustrates an exemplary current-based embodiment of the disclosed method. The current-based embodiment is analogous to the previous voltage based embodiment of FIG. 4, but uses current reference calculation instead of voltage reference calculation. A current i through the series connection of PV panels represents the first quantity and a voltage v over the series connection represents the second quantity. A current reference represents the first quantity reference. An inverter may be used as means for controlling the current through the PV power sources to correspond to the current reference. In this embodiment, the method starts in the minimum permissible current Iₘᵢₙ, and produces a set of increasing current references.

In FIG. 6, in block 62, a highest found power p_{MPP} and a current i_{MPP} are initialized with the values of the voltage v over the PV power sources and the power iv produced by the PV power sources. In order to calculate the power, the voltage v and a current i sources are determined. A current reference i_{ref} is set to the determined current i. In FIG. 6, the current i_{MPP} represents the first parameter.

Similar to the embodiment of FIG. 4, there are two possibilities to generate the next reference. The new current reference i_{ref,k+1} may be computed by adding a minimum increment ΔI to the previous voltage reference I_{ref,k}:

i_{ref,k+1}=i_{ref,k}+ΔI (4)

Alternatively, a trajectory of the hyperbole representing the MPP with highest power may be followed. The new reference i_{ref,k+1} may be calculated by dividing the highest found power p_{MPP} among the previous visited points in the iv-characteristic curve by the voltage vₖ at point k:

$${i}_{ref , k + 1} = \frac{{p}_{MPP}}{{v}_{k}} \qquad ( 5 )$$

As before, the method can guarantee that the effective increment produced will not be smaller than ΔI. Whenever power pₖ, in a given point k, is larger than the latest maximum power given by p_{MPP}, a new current reference is computed using Equation 4. The MPP is updated with the information of the current iₖ at point k and the power pₖ at point k, i.e., i_{MPP}=iₖ, p_{MPP}=pₖ. However, if the power pₖ is smaller than the highest found power p_{MPP}, the new current reference is computed using Equation 5. If the resulting increment is smaller than ΔI, the method calculates the new current reference using Equation 4. This can guarantee that the increment is not smaller than ΔI. The process stops whenever a maximum permissible current Iₘₐₓ or a minimum permissible voltage Vₘᵢₙ is reached.

In FIG. 6, blocks 63 to 70 represent Equations 4 and 5, and the above rules. In block 63, the voltage v and a current i are determined, and the power p produced by the PV power sources is calculated, for instance, from the determined voltage and current. In block 64, the calculated power p is compared with the highest found power p_{MPP}.

If the calculated power p exceeds the power p_{MPP} in the highest found power point, the highest found power point is updated in block 65 with the values of current i and power p. The current reference i_{ref} is also updated in block 65, and the current i is controlled to correspond to the current reference i_{ref}.

If the calculated power p does not exceed the power p_{MPP} in the highest found power point, an intermediate current iₙ, as a second parameter, is calculated in block 66 by dividing the power p_{MPP} by the voltage v. A sum of the current reference i_{ref} and the minimum increment ΔI is calculated and the intermediate current iₙ is compared in block 67 with the sum.

If the intermediate current iₙ is larger than the sum, the intermediate current iₙ is set as the current reference i_{ref} in block 68. Otherwise, the sum is set as the current reference i_{ref} in block 69.

Next, in block 70, the current reference i_{ref} is compared to a maximum permissible current Iₘₐₓ and the voltage v is compared to a minimum permissible voltage Vₘᵢₙ. If the current reference i_{ref} is less than the current Vₘₐₓ and the voltage v is more than the voltage Vₘᵢₙ, the method is repeated starting from block 63. Otherwise, a global MPP is found, and therefore, the current reference is set, in block 71, to the value of the current i_{MPP} in a highest found power point, and the method ends.

A voltage-based and a current-based searching method can be used separately or combined. Part of the time the current i through the series connection of PV power sources may represent the first quantity and the voltage v over the series connection represents the second quantity, and part of the time the voltage v over the series connection of PV power sources represents the first quantity and the current i through the series connection may represent the second quantity. For instance, it is possible to start a searching process at an arbitrary point of the iv-characteristic curve, and use a current-based search method until a minimum voltage Vₘᵢₙ is reached. This gives a provisional MPP out of which a voltage-based method may then start its search, but now in other direction.

The disclosed embodiments of the method may be performed at periodic intervals. The method may also be performed on other occasions, for instance, whenever it is suspected that a shadowing process arises, or when environmental conditions change drastically.

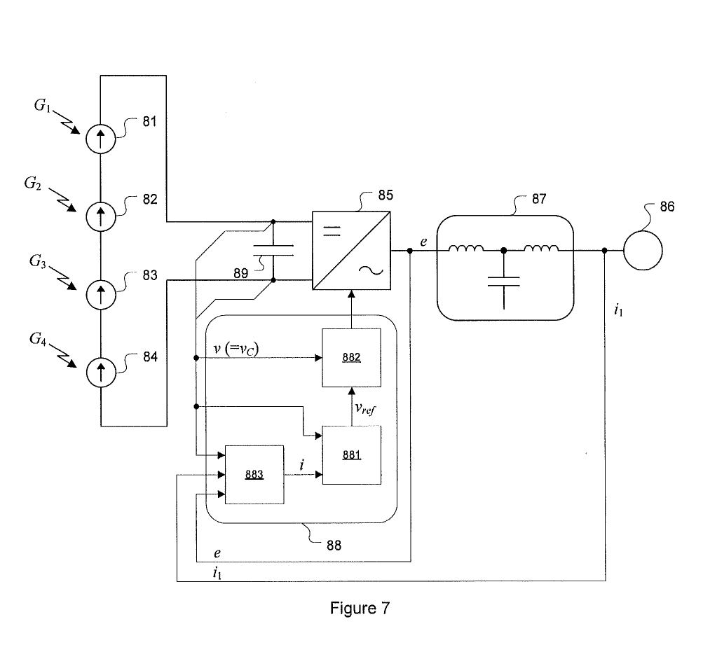

An exemplary implementation of a control system for the method is illustrated in FIG. 7. An exemplary arrangement includes a series connection of photovoltaic power sources 81 to 84. Irradiations of the PV power sources 81 to 84 are denoted by references G₁ to G₄, respectively. The arrangement can further include means for controlling a first quantity of the series connection, wherein one of two following series connection quantities: a voltage v over the series connection and a current i through the series connection, is defined as the first quantity, the other one of the two quantities is defined as a second quantity.

The arrangement may, for instance, include a voltage sensor and a current sensor, as means for determining values for the first quantity and the second quantity, respectively. In other words, a voltage v over the series connection of PV power sources 81 to 84 may represent the first quantity and a current i through the series connection may represent the second quantity. Thus, the apparatus in FIG. 7 may, for instance, be a voltage-based embodiment of the method. However, similar ideas can be applied to the current-based embodiments.

The means for controlling may be an inverter 85, for instance, as in FIG. 7. The inverter 85 may be connected to a grid 86 through a filter 87. The arrangement can also include an apparatus 88 for searching a global maximum power point. The apparatus may, as in FIG. 7, be used to control the voltage v through the inverter 85.

The apparatus 88 may also include a reference calculator 881. The reference calculator 881 may determine a power p produced by the power sources. The outputs of the voltage sensor and the current sensor may, for instance, be used to determine the power p.

The reference calculator 881 may then determine a new value of a first parameter on the basis of a highest found power p_{MPP}, and a new value for the highest found power p_{MPP} on the basis of the determined power p. The first parameter represents the value of the first quantity at the highest found power.

The reference calculator 881 may determine a new value of a first quantity reference by adding an increment to a previous value of the first quantity reference, wherein the value of the increment is determined on the basis of the highest found power.

In the case of a voltage-based method, a voltage reference v_{ref} may represent the first quantity reference. When the first quantity reference or the second quantity reaches a set limit, the reference calculator 881 may end the search and set the first parameter value as the global maximum power point.

The apparatus 88 may also include means for controlling the first quantity on the basis of the first quantity reference. In FIG. 7, the apparatus 88 comprises a voltage controller 882 which controls an inverter bridge of the inverter 85. In current-based embodiments, a current controller may be used instead.

An implementation of the disclosed method may involve definition of two parameters, the sampling interval T_{S} and the minimum increment. In the case of a voltage-based embodiment of FIG. 7, the minimum increment may be represented by a voltage increment ΔV.

It is assumed that voltage over the series connection of PV power sources 81 to 84 is able to reach a reference imposed by the method. The sampling interval T_{S} and the voltage increment ΔV are defined such that they allow a voltage control loop of the voltage controller 882 which can guarantee that the regulation is accomplished before a next step of the voltage reference v_{ref} is produced.

In a dual stage topology, a capacitor voltage response can be quite fast, limited by a quite small time constant of a input filter (usually a CL), and thus tracking of a voltage over the PV power sources towards its reference voltage can be made almost instantaneously.

However, in a single stage topology, as in FIG. 7, the time constant depends on a capacitance of a bulk capacitor 89 in parallel to the series connection of PV power sources 81 to 84. Therefore, provisions may have to be taken in order to increase a speed of response of the voltage loop so that a rapid convergence of the capacitor voltage towards the reference fixed by the method is guaranteed. In the single stage topology, dynamics of a DC component of the capacitor 89 voltage may be described as follows:

v_{C}C\dot{v}_{C=}iv_{C}−P=p−P, (6)

where v_{C} represents a voltage of the capacitor 89 in parallel to the series connection of PV power sources 81 to 84. Thus, v=v_{C} where v the voltage over the PV power sources 81 to 84. Therefore, p=iv_{C} represents a power delivered by the PV power sources 81 to 84, while P is a power reference used to determine an amplitude of a current reference on the grid 86 side. For the voltage controller 882 of FIG. 7, a value of P may, for instance, be obtained by means of a PI controller of the following form:

$$P = {k}_{p} ( {v}_{C} - {v}_{ref} ) + {k}_{i} {\int }_{0}^{t} ( {v}_{C} - {v}_{ref} ) d τ , \qquad ( 7 )$$

where v_{ref} is the voltage reference fixed by the method (or originally by an MPPT method); kₚ and kᵢ are proportional and integral gains of the PI controller, respectively.

A way to accelerate the response is to use a feedforward term for cancelling the term p=iv_{C}, or more precisely, its DC component (p)_{DC}. Moreover, as v_{ref} is a time varying signal, it may be desired to include a term of a form v_{ref}C\dot{v}_{ref} to improve the tracking of v_{C} towards v_{ref}. In other words, the means for controlling the first quantity become a PI controller having a first feedforward term cancelling a DC component of the determined power (p) and a second feedforward term, wherein the second term is a result of a multiplication of the first quantity reference, a capacitance of a capacitor connected in parallel with the PV power sources, and a derivate of the first quantity reference. The following may be used as an enhanced expression of the controller:

$$P = {k}_{p} ( {v}_{C} - {v}_{ref} ) + {k}_{i} {\int }_{0}^{t} ( {v}_{C} - {v}_{ref} ) d τ + {v}_{ref} C {\dot{v}}_{ref} + {〈 p 〉}_{DC} \qquad ( 8 )$$

As v_{ref} may experience stepwise changes, it may be necessary to filter it with a low pass filter (LPF) before using it in Equation 8. For instance, the reference calculator 881 may include a LPF of the form:

$${F}_{1} ( s ) = \frac{1}{τ s + 1} \qquad ( 9 )$$

The reference calculator 881 may also include a filter of the following form for computation of \dot{v}_{ref}:

$${F}_{2} ( s ) = \frac{s}{τ s + 1} \qquad ( 10 )$$

As the extended controller of Equation 8 is more sensitive to high frequency noise, it may be desired to use it only during the search. During operation, when an MPPT determines the reference, a non-extended PI controller may, for instance, be used for controlling.

If the current i through the series-connected PV power sources 81 to 84 is not available, a sensorless embodiment of this method can be used instead. For this purpose, the apparatus 88 may, for instance, include an estimator 883 estimating the current i on the basis of a current i₁ of the inverter on the grid side, a voltage e produced by the inverter and the voltage v_{C} over the capacitor 89, as described next. A model of the capacitor voltage may be given as

$$C {\dot{v}}_{C} = i - \frac{e}{{v}_{C}} {i}_{1} \qquad ( 11 )$$

Based on Equation 11, the following estimator for current i may be formed

$$C {\dot{\hat{v}}}_{C} = \hat{i} - \frac{e}{{v}_{C}} {i}_{1} + α ( {v}_{C} - {\hat{v}}_{C} ) \\ \dot{\hat{i}} = γ ( {v}_{C} - {\hat{v}}_{C} ) \qquad ( 12 )$$

where î and \hat{v}_{C} represent the estimates of i and v_{C}, respectively; α and γ are two positive design parameters, which can be tuned on the basis of a settling time criteria as follows. The system of Equation 11 in closed loop with estimator of Equation 12 yields a second order system, whose characteristic polynomial is Cs²+αs+γ=0. The settling time for such a system can be obtained as

$${T}_{r} = 4.5 ξ \sqrt{\frac{C}{γ}} \qquad ( 13 )$$

considering the 5% criterion. To facilitate the design, a damping ratio of ξ=1 may be considered, out of which the parameters may be tuned as

$$α = \frac{9 C}{{T}_{r}} \\ γ = {C ( \frac{4.5}{{T}_{r}} )}^{2} \qquad ( 14 )$$

The estimation of the DC component of the power can be obtained as follows

[symbol]

p [symbol] _{DC}≅î\hat{v}_{C} (15)

As the product î\hat{v}_{C} may still have second and fourth harmonic components, it may be desired to include notch filters to eliminate these ripples.

The arrangement of FIG. 7 was used in a simulation test. The filter 87 was an LCL filter and the inverter 85 is a single stage inverter. The apparatus 88 operated voltage-based. The current estimator 883 was formed on the basis of Equation 12.

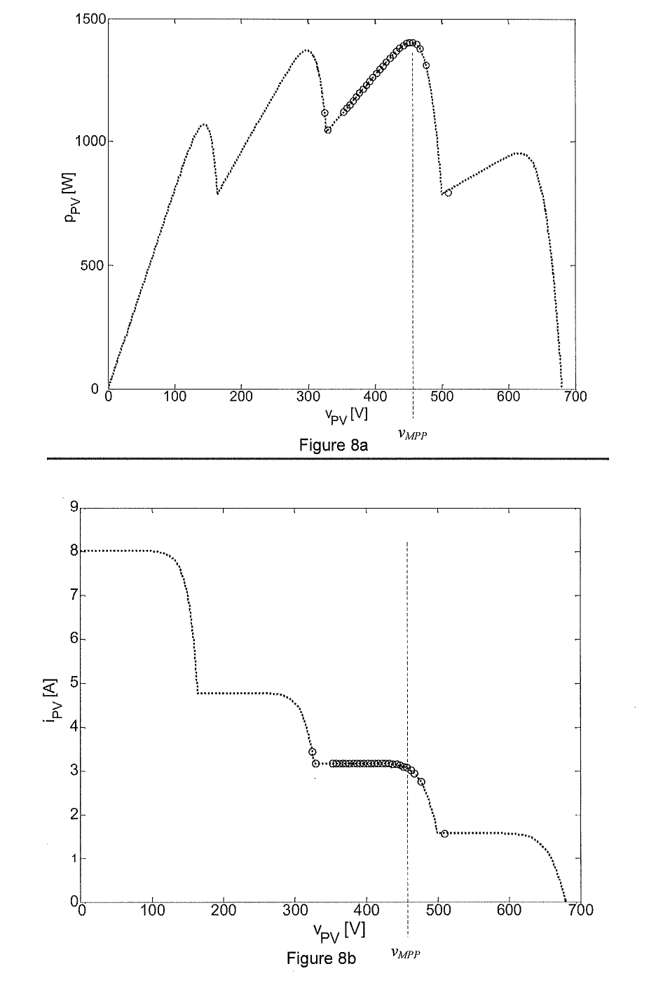

The PV power sources 81 to 84 of FIG. 7 were subjected to different irradiations: G₁=700 W/m², 650, G₁=W/m², 550 G₁=W/m², and 200 G₁=W/m²′. This produced a shape of the characteristic curves as shown in FIGS. 8a and 8b, in which global MPP is located at around v_{MPP}=453 V, with a maximum power p_{MPP} of 1404 W. The grid 86 had a voltage of 230 V_{RMS} and a frequency of 50 Hz. The capacitor 89 parallel to the PV power sources had a capacitance of 2200 uF.

In the simulations, the voltage increment was fixed to ΔV=5 V, and the sampling time was fixed to T_{S}=60 ms. Filters F₁(s) and F₂(s) described by Equations 9 and 10, respectively, were included with time constant t=0.005 s. For the current estimator 883, the following parameters were selected: α=0.9, γ=92, which correspond to a settling time Tᵣ of about 22 ms.

FIG. 8a illustrates a pv-characteristic curve containing several local MPPs and FIG. 8b iv-characteristic curve containing several local MPPs. The points that were tested using the method are plot as circle marks. The searching process started in v=v_{ref}=325 V, which was a minimum allowed to guarantee a proper functioning of the inverter 85. The global MPP is located at around 453 V. After reaching the global MPP, the number of test points is drastically reduced. This permitted to save a considerable amount of time.

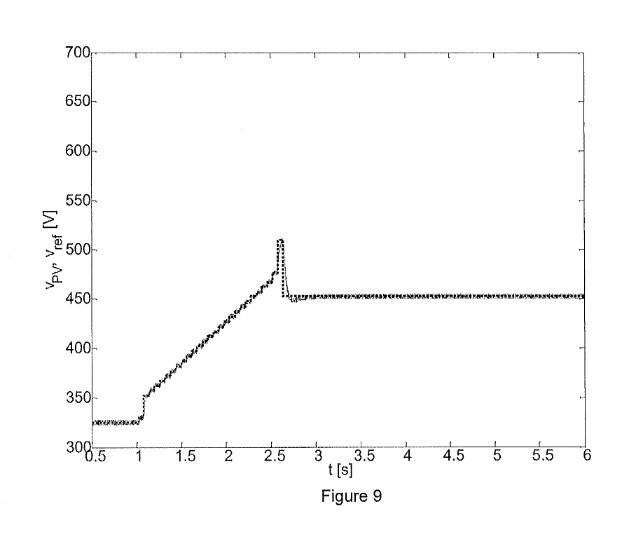

FIG. 9 shows a response (solid line) of the voltage over the PV power sources (or the capacitor) v_{PV} to the voltage reference v_{ref} (dotted line) produced by the apparatus 88. Increments ΔV were always bigger than or equal to ΔV=5 V. In the simulation, the searching process took approximately 1.6 s.

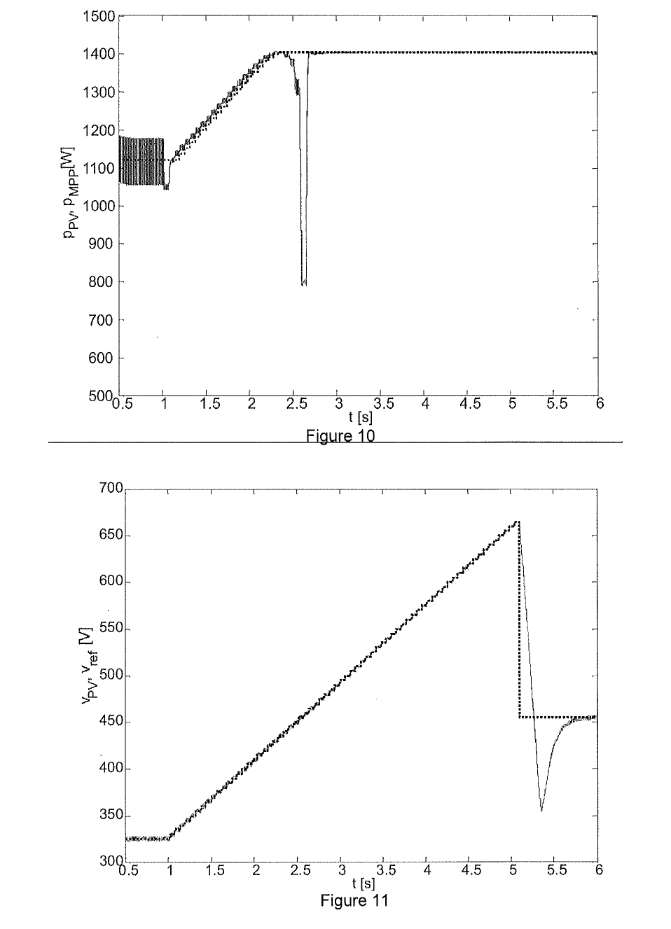

FIG. 10 shows the PV source power (solid line), and the stored highest found power p_{MPP} (dotted line). Once the MPP is reached, it takes a short time to finish with the testing process due to the increasing on the voltage increments ΔV.

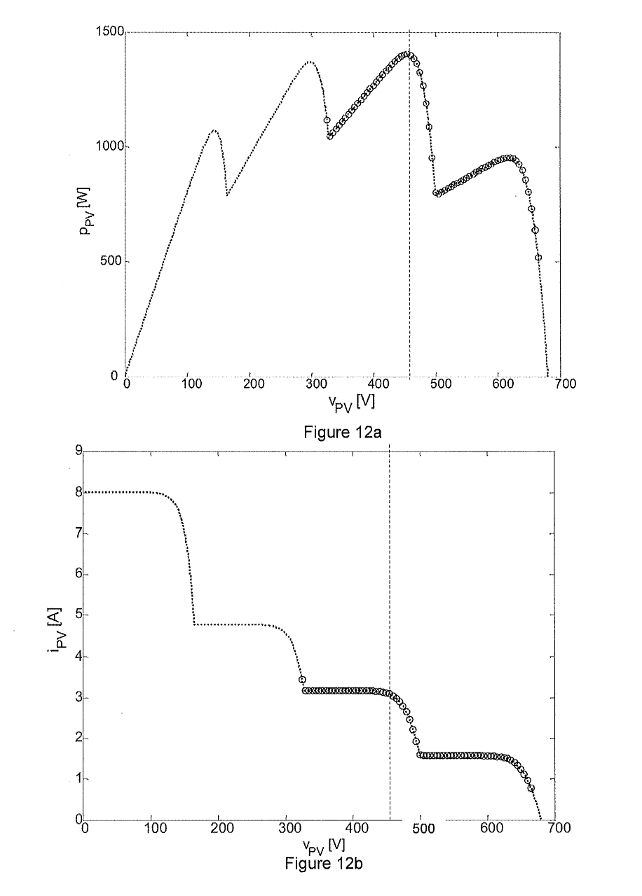

For comparison purposes, a simple known sweep method was also simulated. The increment was fixed to ΔV=5 V, and the sampling time to T_{S}=60 ms, the same as in the simulation of the embodiment of FIG. 7. FIG. 11 illustrates a response of the PV power source voltage v_{C} (solid line) to the voltage reference v_{ref} (dotted line) produced by the known searching method. The sweep method took at least twice the time to finish the searching process when compared to FIG. 9. A drawback with known sweep method is that it evaluates the iv-characteristic curve point by point from Vₘᵢₙ to Vₘₐₓ at a regular interval, as shown in FIGS. 12a and 12b, in which more points are evaluated than in FIG. 8a and 8b. FIG. 12a illustrates pv-characteristic curve containing several local MPPs, and FIG. 12b illustrates iv-characteristic curve containing several local MPPs. The points that were tested using the method are plotted as circle marks.

For an experimental test of the arrangement of FIG. 7, a programmable power supply was used to emulate PV power sources 81 to 84. The filter 87 was an LCL filter and the inverter 85 is a single stage inverter. The apparatus 88 operated voltage-based. The current estimator 883 was formed on the basis of Equation 12. In the test, the PV power sources were emulated to have different irradiations: G₁=350 W/m², G₂=325 W/m², G₃=225 W/m², G₄=100 W/m². This produced similar shape of the characteristic curves as shown in FIGS. 8a and 8b, except that the current was scaled to approximately the half. The global MPP in this case was located at around v_{MPP}=229 V, with a maximum power of about p_{MPP}=700 W.

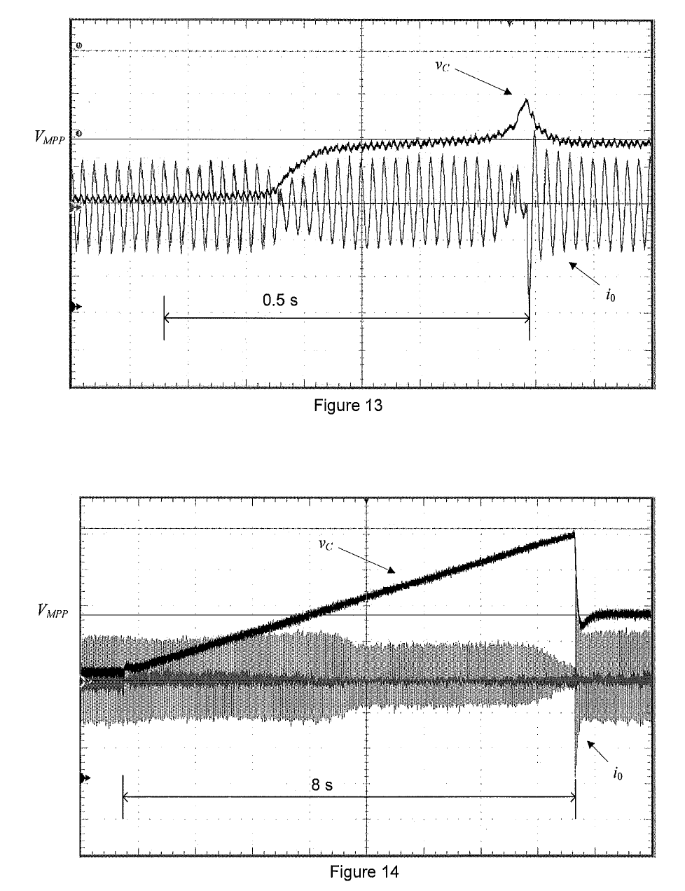

The LCL filter 87 had parameters L₁=1.7 mH, L₀=670 mH and C₀=4.4 mF. The grid 86 had a voltage of 100 V_{RMS} and a frequency of 50 Hz. On the DC side, the capacitor 89 had a capacitance of 940 mF. The voltage increment was set to ΔV=2 V and the sampling time T_{S} was fixed to 20 ms. Filters F₁(s) and F₂(s) described by Equations 9 and 10, respectively, were included with time constant τ=25 μs. For the current estimator 883, the following parameters were selected: α=5, γ=35. FIG. 13 shows a response of the PV power source voltage v_{C} (or capacitor voltage) to the voltage reference produced by the apparatus 88. The current i₀ injected to the grid 86 is also shown. In the test, the searching process took approximately 0.5 s to find the global MPP.

The known simple sweep method was also implemented. Similarly, the increment was fixed to ΔV=2 V, and the sampling time T_{S} was set to 20 ms. FIG. 14 shows that it took the sweep method 8 s to finish the searching process, which is considerably longer than the 0.5 s when using the disclosed method.

The method and related apparatus are described above with reference to the respective functions they perform according to exemplary embodiments. It is to be understood that one or more of these elements and functions can be implemented in a hardware configuration. For example, the respective components may include a computer processor configured to execute computer-readable instructions (e.g. computer-readable software), a non-volatile computer-readable recording medium, such as a memory element (e.g. ROM, flash memory, optical memory, etc.) configured to store such computer-readable instructions, and a volatile computer-readable recording medium (e.g. RAM) configured to be utilized by the computer processor as working memory while executing the computer-readable instructions. The methods and related apparatus may also be configured to sense, generate and/or operate in accordance with analog signals, digital signals and/or a combination of digital and analog signals to carry out their intended functions.

It will be apparent to those skilled in the art that inventive features disclosed herein can be implemented in various ways. The invention and its embodiments are not limited to the examples described herein but may vary within the scope of the claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCES

Documents cited throughout the specification are incorporated herein by reference in their entireties, and include:
[1] H. Patel and V. Agarwal, “MATLAB-Based Modeling to study the effects of partial shading on PV array characteristics,” IEEE Trans. on Energy Conversion, Vol. 23(1), pp. 302-310, March 2008.
[2] K. Irisawa, T. Saito, I. Takano and Y. Sawada, “Maximum power point tracking control of photovoltaic generation system under non-uniform insolation by means of monitoring cells,” in Proc. 28th IEEE Photovoltaic Specialists Conference, 15-22 Sep. 2000, pp. 1707-1710.
[3] K. Kobayashi, I. Takano and Y. Sawada, “A study on a two stage maximum power point tracking control of a photovoltaic system under partially shaded insolation conditions,” in Proc. IEEE Power Engineering Society General Meeting 2003, 13-17 Jul. 2003, Vol. 4, pp. 2612-2617.
[4] H. P. Schwefel, Evolution and optimum seeking, John Wiley & Sons, Inc., New York, 1995.
[5] M. Miyatake, T. Inada, I. Hiratsuka, H. Zhao, H. Otsuka and M. Nakano, “Control characteristics of a Fibonacci-search-based maximum power point tracker when a photovoltaic array is partially shaded,” in Proc. 4th International Power Electronics and Motion Control Conference IPEMC 2004, 14-16 Aug. 2004, Vol. 2, pp. 816-821.
[6] M. Miyatake, F. Toriumi, T. Endo and N. Fujii, “A novel maximum power point tracker controlling several converters connected to photovoltaic arrays with particle swarm optimization technique,” in Proc. European Conference on Power Electronics and Applications EPE07, 2-5 Sep. 2007, pp. 1-10.
[7] H. Patel and V. Agarwal, “Maximum power point tracking scheme for PV systems operating under partially shaded conditions,” IEEE Trans. on Industrial Electronics, Vol. 55(4), pp. 1689-1698, April 2008.
[8] Pandey, “High-performance algorithms for drift avoidance and fast tracking in solar MPPT system,” IEEE Transactions on Energy Conversion, Vol. 23(2), pp. 681-689, June 2008.

1. A method for searching a global maximum power point in an arrangement having a series connection of photovoltaic power sources, and means for controlling a first quantity of the series connection, wherein one of two series connection quantities which represent a voltage over the series connection and a current through the series connection is defined as the first quantity, and another of the two series connection quantities is defined as a second quantity, and wherein the method comprises:
determining values for the first quantity and the second quantity;
determining a power (p) produced by the power sources;
setting the value of the first quantity as a first parameter, when the value of the determined power exceeds a highest found power (p_{MPP}), wherein the first parameter represents the value of the first quantity at the highest found power;
setting the determined power (p) as a new value of the highest found power, when the value of the determined power (p) exceeds a present value of the highest found power;
determining a value of a first quantity reference by adding an increment to a previous value of the first quantity reference, wherein a value of the increment is determined based on the highest found power;
controlling the first quantity based on the first quantity reference; and
setting the first parameter value as the global maximum power point, when the first quantity reference or the second quantity has reached a set limit.

2. A method according to claim 1, wherein determining the value of the first quantity reference comprises:
calculating a sum of the first quantity reference and a minimum increase;
calculating a second parameter by dividing the highest found power (p_{MPP}) by the second quantity and comparing the second parameter with the sum, provided the value of the determined power (p) does not exceed the highest found power (p_{MPP});
setting the second parameter as the first quantity reference, provided the value of the determined power (p) does not exceed the highest found power (p_{MPP}) and the second parameter is larger than the sum, otherwise setting the sum as the first quantity reference.

3. A method according to claim 1, wherein a voltage (v) over the series connection of PV power sources represents the first quantity and a current (i) through the series connection represents the second quantity.

4. A method according to claim 1, wherein current (i) through the series connection of PV power sources represents the first quantity and voltage (v) over the series connection represents the second quantity.

5. A method according to claim 1, wherein, for at least a part of a time, current (i) through the series connection of PV power sources represents the first quantity and voltage (v) over the series connection represents the second quantity, and, for another part of the time, the voltage (v) over the series connection of PV power sources represents the first quantity and the current (i) through the series connection represents the second quantity.

6. An apparatus for searching a global maximum power point of an arrangement having a series connection of photovoltaic (Pv) power sources, wherein one of two series connection quantities which represent a voltage over the series connection and a current through the series connection is defined as a first quantity, and another the two quantities is defined as a second quantity, the apparatus comprising:
means for determining a power (p) produced by power sources;
means for determining a value of a first parameter based on a highest found power, wherein the first parameter represents a value of the first quantity at the highest found power;
means for determining a new value for the highest found power based on the determined power (p);
means for determining a value of a first quantity reference by adding an increment to a previous value of the first quantity reference, wherein the value of the increment is determined based on the highest found power; and
means for setting the first parameter value as a global maximum power point, when the first quantity reference or the second quantity has reached a set limit.

7. An apparatus according to claim 6, comprising:
means for controlling the first quantity based on the first quantity reference.

8. An apparatus according to claim 7, comprising:
means for estimating current (i) through PV power sources based on a current of an inverter on the grid side during operation, a voltage (e) produced by the inverter, and a voltage (v_{C}) over a capacitor connected in parallel with the PV power sources.

9. An apparatus according to claim 7, wherein the means for controlling the first quantity is a PI controller comprising:
a first feedforward term cancelling a DC component of determined power (p); and
a second feedforward term, wherein the second term is formed by a multiplication of the first quantity reference, a capacitance of a capacitor connected in parallel with the PV power sources, and a derivate of the first quantity reference.

10. A method according to claim 2, wherein a voltage (v) over the series connection of PV power sources represents the first quantity and a current (i) through the series connection represents the second quantity.

11. A method according to claim 2, wherein current (i) through the series connection of PV power sources represents the first quantity and voltage (v) over the series connection represents the second quantity.

12. A method according to claim 2, wherein, for at least a part of a time, current (i) through the series connection of PV power sources represents the first quantity and voltage (v) over the series connection represents the second quantity, and, for another part of the time, the voltage (v) over the series connection of PV power sources represents the first quantity and the current (i) through the series connection represents the second quantity.

13. An apparatus according to claim 6, in combination with:
means for controlling the first quantity of the series connection; and
means for determining values for the first quantity and the second quantity.

14. An apparatus according to claim 13, in combination with an arrangement having a series connection of photovoltaic ((Pv) power sources.
